(19) United States
(12) Patent Application Publication
(10) Pub. No.: US 2019/0281264 A1
(43) Pub. Date: Sep. 12, 2019

(54) PROJECTION DISPLAY DEVICE, METHOD FOR CONTROLLING PROJECTION DISPLAY DEVICE, AND PROGRAM FOR CONTROLLING PROJECTION DISPLAY DEVICE

(71) Applicant: FUJIFILM Corporation, Tokyo (JP)

(72) Inventor: Koudai FUJITA, Saitama (JP)

(73) Assignee: FUJIFILM Corporation, Tokyo (JP)

(21) Appl. No.: 16/423,045

(22) Filed: May 27, 2019

Related U.S. Application Data
(63) Continuation of application No. PCT/JP2017/036270, filed on Oct. 5, 2017.

(30) Foreign Application Priority Data
Dec. 19, 2016 (JP) 2016-245679

(51) Int. Cl. H04N 9/31; G02B 27/01; G03B 21/14

(52) U.S. Cl. CPC H04N 9/3155; G03B 21/142; G02B 27/0101

(57) ABSTRACT

An HUD includes a detection unit, a projection display unit, and a display control unit. The detection unit detects a position of a construction machine and a direction of a driver's cabin. The projection display unit projects image light onto a projection area of a front windshield of the driver's cabin to display a virtual image. The display control unit controls the image information and controls the virtual image that is to be displayed by the projection display unit. The display control unit causes the projection display unit to display a bucket virtual image that represents a bucket on the basis of operation plan information and the position and the direction of the construction machine detected by the detection unit, the operation plan information specifying the position of the construction machine, the direction of the driver's cabin, and a posture of the bucket that are stored in a storage unit.

### CROSS-REFERENCE TO RELATED APPLICATIONS

This application is a Continuation of PCT International Application No. PCT/JP2017/036270 filed on Oct. 5, 2017, which claims priority under 35 U.S.C § 119(a) to Japanese Patent Application No. 2016-245679 filed on Dec. 19, 2016. Each of the above application(s) is hereby expressly incorporated by reference, in its entirety, into the present application.

### BACKGROUND OF THE INVENTION

### 1. Field of the Invention

The present invention relates to a projection display device, a method for controlling the projection display device, and a program for controlling the projection display device.

### 2. Description of the Related Art

JP2014-129676A and JP2010-018141A disclose techniques of improving operation efficiency at the time of construction work by using various operational machines in which an operator of a hydraulic shovel, a wheel loader, a bulldozer, a motor grader, or the like can observe a working machine from a driver's cabin by using a heal-up display (HUD).

JP2014-129676A discloses a hydraulic shovel that displays information of an ascending-and-descending direction and an ascent-and-descent amount of a bucket ahead of a driver's seat.

JP2010-018141A discloses a hydraulic shovel that displays an execution scheme drawing ahead of the driver's seat by using the HUD.

JP2012-255286A discloses a hydraulic shovel that displays an execution scheme drawing, information indicating the current execution situation, and a bucket image indicating the position of a bucket in the current situation on a display apparatus within the driver's cabin.

### SUMMARY OF THE INVENTION

According to the techniques in JP2010-018141A and JP2012-255286A, the operator can operate the operation machine while checking the execution scheme drawing, and thus, the operation efficiency can be improved. However, only with the display of the execution scheme drawing and the current position of the bucket, it is difficult for an inexperienced operator to perform execution as intended.

According to the technique in JP2014-129676A, since the ascent-and-descent amount of the bucket is displayed together with the execution scheme drawing, it is effective as operational support for the inexperienced operator. However, a range in which execution is to be performed may be wide in some cases, and in these cases, the operator needs to determine the position at which the bucket is to ascend and descend in the range in which execution is to be performed. JP2014-129676A does not consider the necessity for supporting such determination.

In addition, with the hydraulic shovel in JP2014-129676A, it may be considered that the operator rotates or moves forward a vehicle body to move and stop the bucket at an appropriate position to repeat a process of operating the bucket in accordance with the up-and-down amount displayed by the HUD at this position. With such a process, depending on the experienced level of the operator, the vehicle body may be moved more than necessary, and the operation efficiency may decrease.

Although the construction machine has been described above as an example, an object of improving the operation efficiency arises similarly for an HUD that is to be mounted in a vehicle (e.g., forklift) on which a working machine that can be operated by the operator ahead of the driver's seat is mounted.

The present invention has been made in view of the above circumstances, and an object is to provide a projection display device that can improve the operation efficiency of a vehicle having a working machine, a method for controlling the projection display device, and a program for controlling the projection display device.

A projection display device according to the present invention is a projection display device to be mounted in a vehicle having a movable working machine and a main body part, the working machine being attached to the main body part, the main body part having a driver's cabin. The projection display device includes: a detection unit, a projection display unit, and a display control unit. The detection unit detects a position of the vehicle and a direction of the driver's cabin. The projection display unit includes a light modulation unit that, on the basis of image information to be input, spatially modulates light emitted from a light source, and projects image light, obtained through spatial modulation by the light modulation unit, onto a projection surface mounted in the driver's cabin to display a virtual image based on the image light. The display control unit controls the image information to be input to the light modulation unit and that controls the virtual image that is to be displayed by the projection display unit. The display control unit causes the projection display unit to display a working-machine virtual image that represents the working machine on the basis of operation plan information and the position and the direction detected by the detection unit, the operation plan information specifying the position of the vehicle, the direction of the driver's cabin, and a posture of the working machine that are stored in a storage unit.

A method for controlling a projection display device according to the present invention is a method for controlling a projection display device, the projection display device being to be mounted in a vehicle having a movable working machine and a main body part, the working machine being attached to the main body part, the main body part having a driver's cabin. The projection display device has a light modulation unit and a projection display unit. On the basis of image information to be input, the light modulation unit spatially modulates light emitted from a light source. The projection display unit projects image light, obtained through spatial modulation by the light modulation unit, onto a projection surface mounted in the driver's cabin to display a virtual image based on the image light. The method includes: a detection step and a display control step. The detection step detects a position of the vehicle and a direction of the driver's cabin. The display control step causes the projection display unit to display a working-machine virtual image that represents the working machine on the basis of operation plan information and the position and the direction detected in the detection step, the operation plan information specifying the position of the vehicle, the direction of the driver's cabin, and a posture of the working machine that are stored in a storage unit.

A program for controlling a projection display device according to the present invention is a program for controlling a projection display device, the projection display device being to be mounted in a vehicle having a movable working machine and a main body part, the working machine being attached to the main body part, the main body part having a driver's cabin. The projection display device has a light modulation unit and a projection display unit. On the basis of image information to be input, the light modulation unit spatially modulates light emitted from a light source. The projection display unit projects image light, obtained through spatial modulation by the light modulation unit, onto a projection surface mounted in the driver's cabin to display a virtual image based on the image light. The program is for causing a computer to execute: a detection step and a display control step. The detection step detects a position of the vehicle and a direction of the driver's cabin. The display control step causes the projection display unit to display a working-machine virtual image that represents the working machine on the basis of operation plan information and the position and the direction detected in the detection step, the operation plan information specifying the position of the vehicle, the direction of the driver's cabin, and a posture of the working machine that are stored in a storage unit.

According to the present invention, it is possible to provide a projection display device that can improve the operation efficiency of a vehicle having a working machine, a method for controlling the projection display device, and a program for controlling the projection display device.

### BRIEF DESCRIPTION OF THE DRAWINGS

FIG. 1 is a schematic diagram illustrating a schematic configuration of a construction machine in which an HUD that is an embodiment of a projection display device according to the present invention is mounted;

FIG. 2 is a schematic diagram illustrating an internal configuration example of a driver's cabin in the construction machine illustrated in FIG. 1;

FIG. 3 is a schematic diagram illustrating a configuration example within the driver's cabin in the construction machine illustrated in FIG. 1;

FIG. 4 is a schematic diagram illustrating an internal configuration of the HUD illustrated in FIGS. 1 and 2;

FIG. 5 is a functional block diagram of a system control unit illustrated in FIG. 4;

FIG. 6 is a flowchart for describing operations of the system control unit illustrated in FIG. 5;

FIG. 7 is a flowchart for describing operations of the system control unit illustrated in FIG. 5;

FIG. 8 is a schematic diagram illustrating an example of display by a projection display unit of the HUD illustrated in FIG. 1;

FIG. 9 is a schematic diagram illustrating an example of display by the projection display unit of the HUD illustrated in FIG. 1;

FIG. 10 is a schematic diagram illustrating an example of display by the projection display unit of the HUD illustrated in FIG. 1;

FIG. 11 is a schematic diagram illustrating an example of display by the projection display unit of the HUD illustrated in FIG. 1;

FIG. 12 is a schematic diagram illustrating an example of display by the projection display unit of the HUD illustrated in FIG. 1;

FIG. 13 is a schematic diagram illustrating an example of display by the projection display unit of the HUD illustrated in FIG. 1;

FIG. 14 is a schematic diagram illustrating an example of display by the projection display unit of the HUD illustrated in FIG. 1;

FIG. 15 is a schematic diagram illustrating an example of display by the projection display unit of the HUD illustrated in FIG. 1;

FIG. 16 is a schematic diagram illustrating an example of display by the projection display unit of the HUD illustrated in FIG. 1;

FIG. 17 is a schematic diagram illustrating an example of display by the projection display unit of the HUD illustrated in FIG. 1; and

FIG. 18 is a schematic diagram illustrating an example of display by the projection display unit of the HUD illustrated in FIG. 1.

### DESCRIPTION OF THE PREFERRED EMBODIMENTS

Now, an embodiment of the present invention will be described with reference to the drawings.

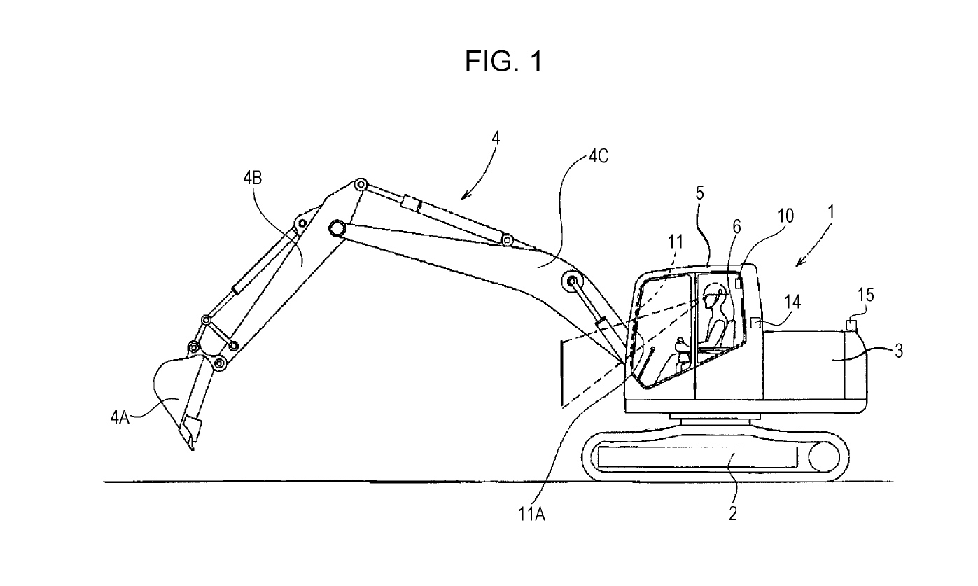

FIG. 1 is a schematic diagram illustrating a schematic configuration of a construction machine 1 in which an HUD 10 that is an embodiment of the projection display device according to the present invention is mounted.

The construction machine 1 is a hydraulic shovel and is composed of units such as an undercarriage 2, an upper rotatable body 3 that is supported by the undercarriage 2 in a rotatable manner, and a front operation unit 4 that is supported by the upper rotatable body 3. The undercarriage 2 and the upper rotatable body 3 constitute a main body part of the construction machine 1.

The undercarriage 2 includes a metal or rubber crawler for traveling on a public road or in a construction site.

The upper rotatable body 3 includes a driver's cabin 5, a direction sensor 14 that detects the direction of the driver's cabin 5, and a global positioning system (GPS) receiver 15 that detects the position (latitude and longitude) of the construction machine 1. In the driver's cabin 5, a control device for controlling the front operation unit 4 and a driver's seat 6 for an operator to be seated are set.

The front operation unit 4 includes an arm 4C, a boom 4B, and a bucket 4A. The arm 4C is supported by the upper rotatable body 3 such that the arm 4C is movable in the gravity direction and a direction perpendicular to the gravity direction (vertical direction in the drawing and direction perpendicular to the drawing). The boom 4B is supported by the arm 4C such that the boom 4B is rotatable relative to the arm 4C. The bucket 4A is supported by the boom 4B such that the bucket 4A is rotatable relative to the boom 4B. The bucket 4A is a part that can directly contact a target such as the earth or an object to be carried and constitutes a working machine.

Note that instead of the bucket 4A, another working machine, such as a steel frame cutting machine, a concrete crushing machine, a grabbing machine, or a hitting breaker, may be attached to the boom 4B.

The bucket 4A is movable in the vertical direction of the drawing relative to the driver's cabin 5 via the arm 4C and the boom 4B. In addition, the bucket 4A is rotatable around axes that are the line-of-sight direction of the operator who is seated on the driver's seat 6 and a direction perpendicular to the gravity direction. In addition, the boom 4B is rotatable around an axis that is perpendicular to the drawing.

Although omitted from the illustration, a group of sensors such as an angular rate sensor and a three-axis acceleration sensor for detecting the posture of the front operation unit 4 is provided in the front operation unit 4.

The driver's cabin 5 is provided with a front windshield 11 ahead of the driver's seat 6, and a part of the front windshield 11 is a region processed to reflect image light, which will be described later. Furthermore, this region constitutes a projection area 11A onto which image light emitted from the HUD 10 is projected. The direction sensor 14 is provided for detecting the direction of a front surface of the front windshield 11.

The HUD 10 is set within the driver's cabin 5 and displays a virtual image with image light projected onto the projection area 11A, which is a part of a region of the front windshield 11, so that the operator who is seated on the driver's seat 6 can visually recognize the virtual image ahead of the front windshield 11.

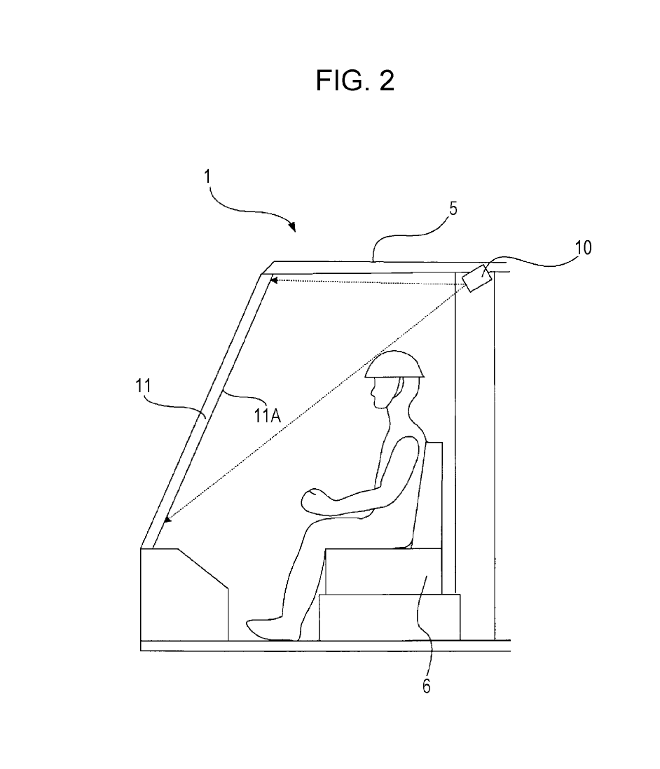

FIG. 2 is a schematic diagram illustrating an internal configuration example of the driver's cabin 5 in the construction machine 1 illustrated in FIG. 1.

As illustrated in FIG. 2, the HUD 10 is provided above and in the back of the operator in a state where the operator is seated on the driver's seat 6. On the basis of a detected signal of the GPS receiver 15, a detected signal of the direction sensor 14, detected signals of the group of sensors provided in the front operation unit 4, and operation plan information that is stored inside in advance, the HUD 10 displays a virtual image for operational support ahead of the front windshield 11.

By seeing image light that has been projected onto and reflected on the projection area 11A of the front windshield 11, the operator of the construction machine 1 can visually recognize, as a virtual image, information such as an image or characters for supporting the operation by using the construction machine 1. The projection area 11A has a function of reflecting the image light projected from the HUD 10 and transmitting light from the outdoor space (the outside) at the same time. Thus, the operator can visually recognize the virtual image based on the image light projected from the HUD 10, the virtual image overlapping with the outside scene.

Although the HUD 10 is mounted in the hydraulic shovel in the example in FIG. 1, the HUD 10 may be similarly mounted in any machine (e.g., a wheel loader, a bulldozer, a motor grader, or a forklift) in which an operator-controllable working machine is mounted ahead of the driver's seat.

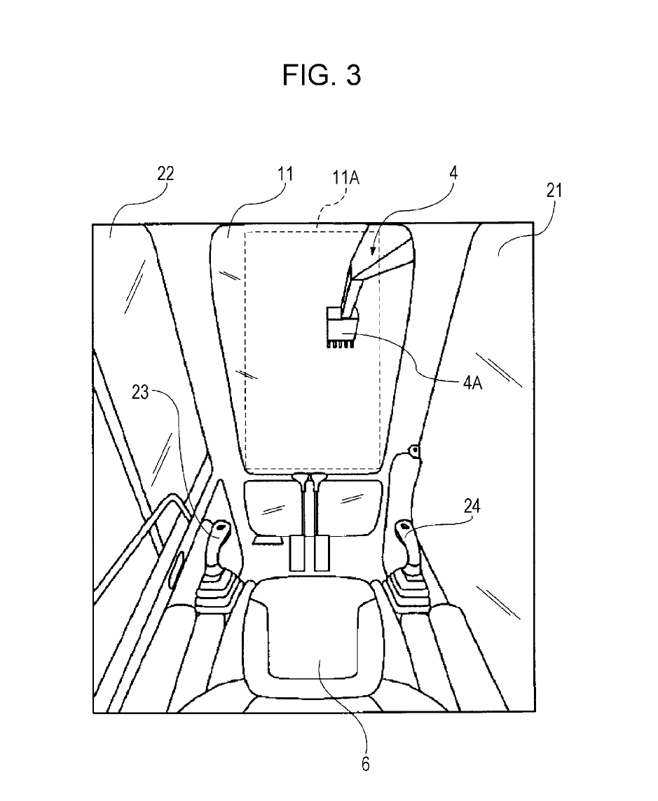

FIG. 3 is a schematic diagram illustrating a structure example within the driver's cabin 5 in the construction machine 1 illustrated in FIG. 1.

The driver's cabin 5 is surrounded by the front windshield 11, a right-side windshield 21, and a left-side windshield 22. The driver's cabin 5 includes a left control lever 23, a right control lever 24, and the like around the driver's seat 6. The left control lever 23 is for controlling folding and stretching of the front operation unit 4 and rotation of the upper rotatable body 3. The right control lever 24 is for controlling digging and releasing of the bucket 4A in the front operation unit 4. Note that the operation functions assigned to the left control lever 23 and the right control lever 24 are examples and are not limited to the above examples.

The front windshield 11 has the projection area 11A onto which the image light emitted from the HUD 10 is projected, and the projection area 11A reflects the image light and transmits light from the outdoor space (the outside) at the same time.

Note that the construction machine 1 is equipped with, although omitted from the illustration, a steering for running, an acceleration, a brake, and the like that are operated when running by using the undercarriage 2.

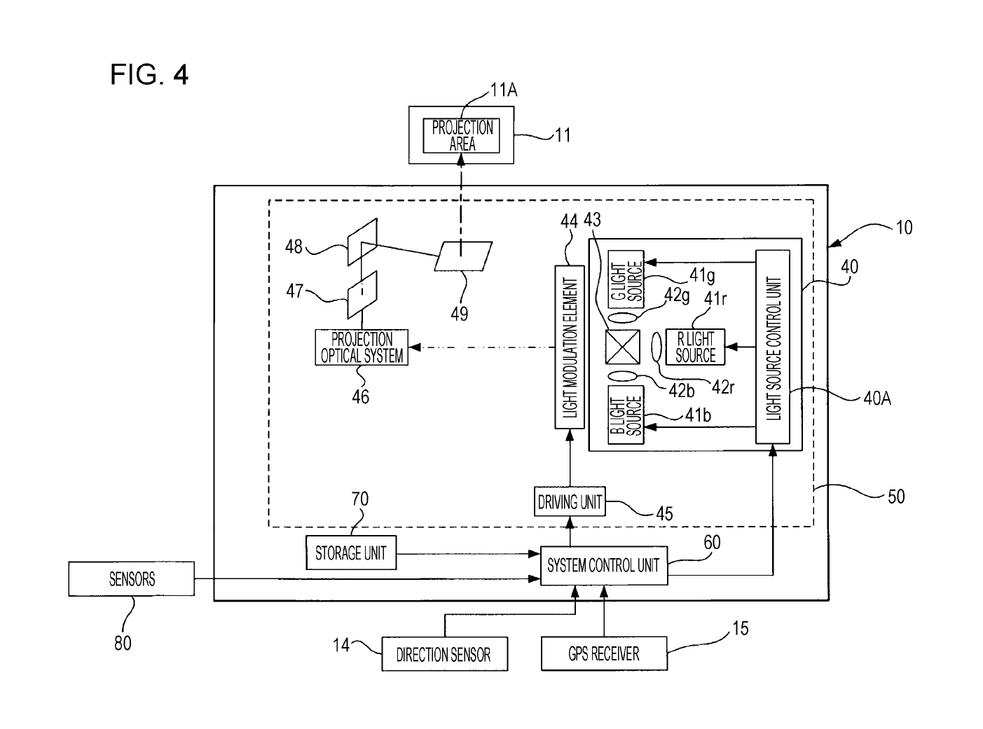

FIG. 4 is a schematic diagram illustrating an internal configuration of the HUD 10 illustrated in FIGS. 1 and 2.

The HUD 10 includes a light source unit 40, a light modulation element 44, a driving unit 45 that drives the light modulation element 44, a projection optical system 46, a diffusion plate 47, a reflective mirror 48, a magnifying glass 49, a system control unit 60 that controls the light source unit 40 and the driving unit 45, and a storage unit 70 that may be composed of a storage medium such as a flash memory.

The light source unit 40 includes a light source control unit 40A, an R light source 41r, a G light source 41g, a B light source 41b, a dichroic prism 43, a collimator lens 42r, a collimator lens 42g, and a collimator lens 42b. The R light source 41r is a red light source that emits red light, the G light source 41g is a green light source that emits green light, and the B light source 41b is a blue light source that emits blue light. The collimator lens 42r is provided between the R light source 41r and the dichroic prism 43, the collimator lens 42g is provided between the G light source 41g and the dichroic prism 43, and the collimator lens 42b is provided between the B light source 41b and the dichroic prism 43.

The dichroic prism 43 is an optical member for guiding light emitted from each of the R light source 41r, the G light source 41g, and the B light source 41b to the same optical path. That is, the dichroic prism 43 transmits red light collimated by the collimator lens 42r and emits the red light to the light modulation element 44. In addition, the dichroic prism 43 reflects green light collimated by the collimator lens 42g and emits the green light to the light modulation element 44. Furthermore, the dichroic prism 43 reflects blue light collimated by the collimator lens 42b and emits the blue light to the light modulation element 44. The optical member having such a function is not limited to the dichroic prism. For example, a cross dichroic mirror may also be used.

For each of the R light source 41r, the G light source 41g, and the B light source 41b, a light emitting element such as a laser or a light emitting diode (LED) is used. The R light source 41r, the G light source 41g, and the B light source 41b constitute a light source of the HUD 10. Although the light source of the HUD 10 includes three light sources, which are the R light source 41r, the G light source 41g, and the B light source 41b, in this embodiment, the number of light sources may be one, two, or four or more.

The light source control unit 40A sets the light emission amount of each of the R light source 41r, the G light source 41g, and the B light source 41b to a predetermined light emission amount pattern, and performs control so as to cause the R light source 41r, the G light source 41g, and the B light source 41b to sequentially emit light in accordance with the light emission amount pattern.

The light modulation element 44 spatially modulates the light emitted from the dichroic prism 43 on the basis of image information and emits the spatially modulated light (red image light, blue image light, and green image light) to the projection optical system 46.

As the light modulation element 44, for example, a liquid crystal on silicon (LCOS), a digital micromirror device (DMD), a micro electro mechanical systems (MEMS) element, a liquid crystal display element, or the like can be used.

On the basis of image information that is input from the system control unit 60, the driving unit 45 drives the light modulation element 44 to cause light (red image light, blue image light, and green image light) in accordance with image information to be emitted from the light modulation element 44 to the projection optical system 46.

The light modulation element 44 and the driving unit 45 constitute a light modulation unit of the HUD 10.

The projection optical system 46 is an optical system for projecting the light emitted from the light modulation element 44 onto the diffusion plate 47. This optical system is not limited to a lens, and a scanner can also be used. For example, light emitted from a scanner may be diffused by the diffusion plate 47 to form a plane light source.

The reflective mirror 48 reflects the light diffused by the diffusion plate 47 toward the magnifying glass 49.

The magnifying glass 49 enlarges and projects an image based on the light reflected on the reflective mirror 48 onto the projection area 11A.

The light source unit 40, the light modulation element 44, the driving unit 45, the projection optical system 46, the diffusion plate 47, the reflective mirror 48, and the magnifying glass 49 constitute a projection display unit 50. The projection display unit 50 spatially modulates light emitted from the R light source 41r, the G light source 41g, and the B light source 41b on the basis of image information that is input from the system control unit 60 and projects the spatially modulated image light onto the projection area 11A. The projection area 11A constitutes a display area in which a virtual image can be displayed by the projection display unit 50.

The system control unit 60 controls the light source control unit 40A and the driving unit 45 so as to cause image light based on image information to be emitted to the diffusion plate 47 through the projection optical system 46.

The diffusion plate 47, the reflective mirror 48, and the magnifying glass 49 illustrated in FIG. 4 are optically designed such that an image based on the image light projected onto the projection area 11A can be visually recognized as a virtual image at a position ahead of the front windshield 11.

The system control unit 60 is mainly composed of a processor and includes a read only memory (ROM) in which a program to be executed by the processor or the like is stored, a random access memory (RAM) as a work memory, and the like.

The storage unit 70 stores a plurality of operation plan information items.

The operation plan information is information that specifies each of the position (latitude and longitude) of the construction machine 1 at which digging by using the bucket 4A is to be started, the direction of the driver's cabin 5 at that position, the posture of the bucket 4A (including the position of the bucket 4A in the vertical direction, the distance to the bucket 4A from the driver's cabin 5, and the like) at the time of start of digging at that position, and the digging amount at that position. Note that the information on the digging amount may be omitted from the operation plan information.

Hereinafter, the position of the construction machine 1 specified by the operation plan information will be called planned position, the direction of the driver's cabin 5 specified by the operation plan information will be called planned direction, and the posture of the bucket 4A specified by the operation plan information will be called planned posture.

Sensors 80 illustrated in FIG. 4 are a three-axis acceleration sensor, an angular rate sensor, and the like provided in the front operation unit 4. The acceleration information and angular rate information detected by the sensors 80, the direction information indicating the direction of the driver's cabin 5 detected by the direction sensor 14, and the position information of the construction machine 1 indicating the latitude and longitude detected by the GPS receiver 15 are input to the system control unit 60.

On the basis of the operation plan information that is read out from the storage unit 70, the direction information that is input from the direction sensor 14, and the position information that is input from the GPS receiver 15, the system control unit 60 generates image information for displaying a working-machine virtual image that represents the bucket 4A and causes image light based on the image information to be projected onto the projection area 11A. Note that the HUD 10 includes the storage unit 70 in this non-limiting example. The HUD 10 may read out the operation plan information that is stored in a storage medium that is externally attached to the HUD 10. Alternatively, the HUD 10 may read out the operation plan information from a storage medium that is outside the construction machine 1 through a network.

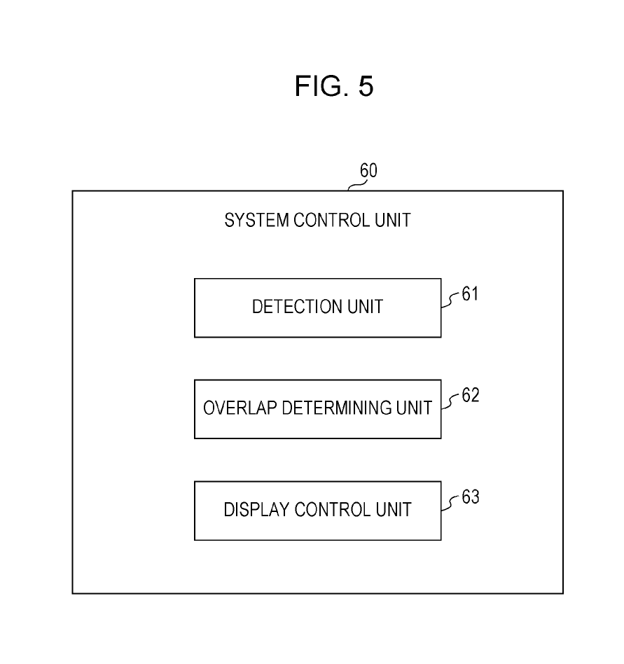

FIG. 5 is a functional block diagram of the system control unit 60 illustrated in FIG. 4.

The system control unit 60 includes a detection unit 61, an overlap determining unit 62, and a display control unit 63. The detection unit 61, the overlap determining unit 62, and the display control unit 63 are functional blocks formed by the processor of the system control unit 60 executing programs including a control program stored in the ROM.

On the basis of the acceleration information and angular rate information that are input from the sensors 80, the detection unit 61 detects the posture of the bucket 4A determined on the basis of the position of the bucket 4A in the vertical direction and the distance to the bucket 4A from the driver's cabin 5. The posture of the bucket 4A detected by the detection unit 61 will be called detected posture below.

In addition, the detection unit 61 detects the direction of the driver's cabin 5 (the direction of the front surface of the front windshield 11) on the basis of the direction information that is input from the direction sensor 14. The direction of the driver's cabin 5 detected by the detection unit 61 will be hereinafter called detected direction.

Furthermore, the detection unit 61 detects the position of the construction machine 1 on the basis of the position information that is input from the GPS receiver 15. The position of the construction machine 1 detected by the detection unit 61 will be hereinafter called detected position.

The display control unit 63 controls the image information to be input to the driving unit 45 and controls the virtual image to be displayed by the projection display unit 50.

On the basis of any of the plurality of operation plan information items stored in the storage unit 70 and the detected position and detected direction detected by the detection unit 61, the display control unit 63 causes the projection display unit 50 to display a bucket virtual image (working-machine virtual image) that represents the bucket 4A at a predetermined position in the projection area 11A, thereby presenting to the operator, the position of the construction machine 1, the direction of the driver's cabin 5, and the posture of the bucket 4A that are appropriate for starting a digging operation.

In a case where the detected position corresponds with the planned position and the detected direction corresponds with the planned direction, on the basis of the detected posture and the planned posture, the overlap determining unit 62 determines whether the bucket virtual image displayed by the projection display unit 50 overlaps with the bucket 4A in a state where seen from the driver's seat 6. The state where the bucket virtual image overlaps with the bucket 4A includes, in addition to the state where the outline of the bucket virtual image completely overlaps with the outline of the bucket 4A, the state where these two outlines are slightly misaligned.

In addition, the correspondence between the detected position and the planned position means not only the case where the detected position completely corresponds with the planned position but also the case where the difference between the detected position and the planned position is less than or equal to a predetermined value. The correspondence between the detected direction and the planned direction means not only the case where the front surface of the front windshield 11 faces the position for performing a digging operation and the detected direction completely corresponds with the planned direction but also the case where the front surface of the front windshield 11 faces the position for performing a digging operation and the difference between the detected direction and the planned direction is less than or equal to a predetermined value.

Specifically, the overlap determining unit 62 calculates the difference between the detected posture and the planned posture according to the operation plan information stored in the storage unit 70. In a case where the difference is less than a threshold value, the overlap determining unit 62 determines that the bucket virtual image and the bucket 4A overlap with each other in the state where seen from the driver's seat 6. In a case where the difference is greater than or equal to the threshold value, the overlap determining unit 62 determines that the bucket virtual image and the bucket 4A do not overlap with each other in the state where seen from the driver's seat 6.

Note that a digital camera that can capture an image of the same range as the field of view of the operator who is seated on the driver's seat 6 may be installed in the driver's cabin 5, and the overlap determining unit 62 may analyze the image captured by the digital camera so as to determine whether the bucket virtual image that is being displayed by the projection display unit 50 and the bucket 4A overlap with each other in the state where seen from the driver's seat 6.

In the case where the overlap determining unit 62 determines that the bucket virtual image and the bucket 4A overlap with each other in the state where seen from the driver's seat 6, the display control unit 63 generates image information including report information for informing the operator that the state where the digging operation is to be started is set, inputs this report information to the driving unit 45, and causes the report information to be displayed.

The report information is information for reporting that the bucket 4A corresponds with the planned posture and is information such as an image or characters that can be visually recognized by the operator easily.

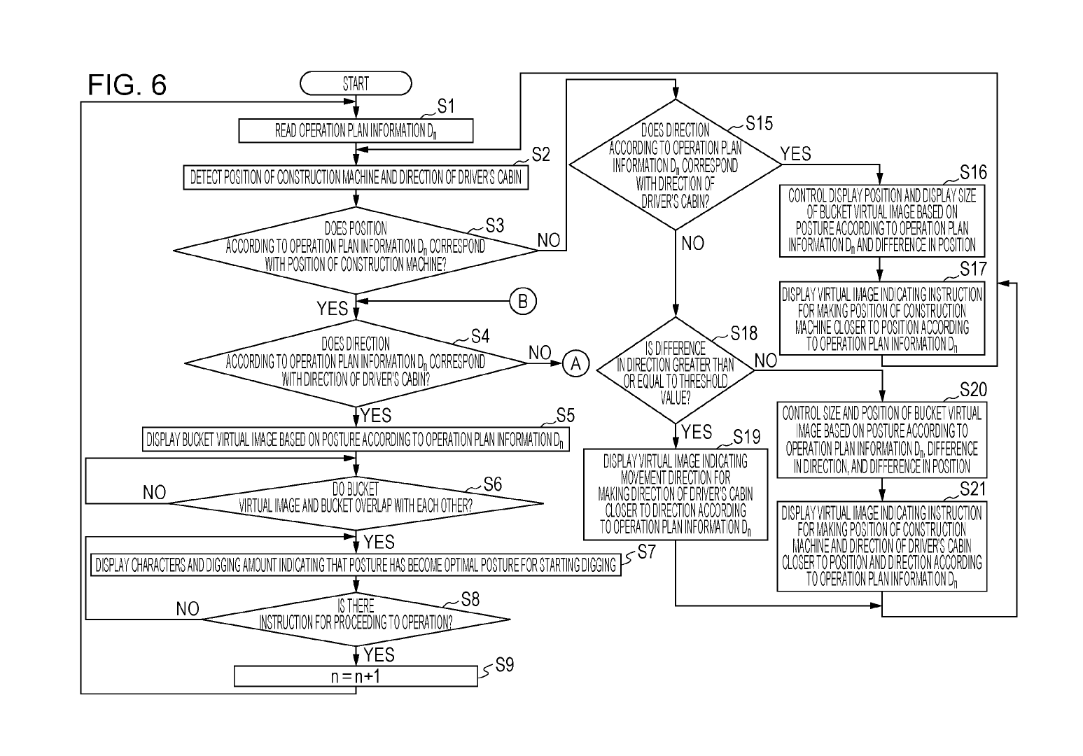

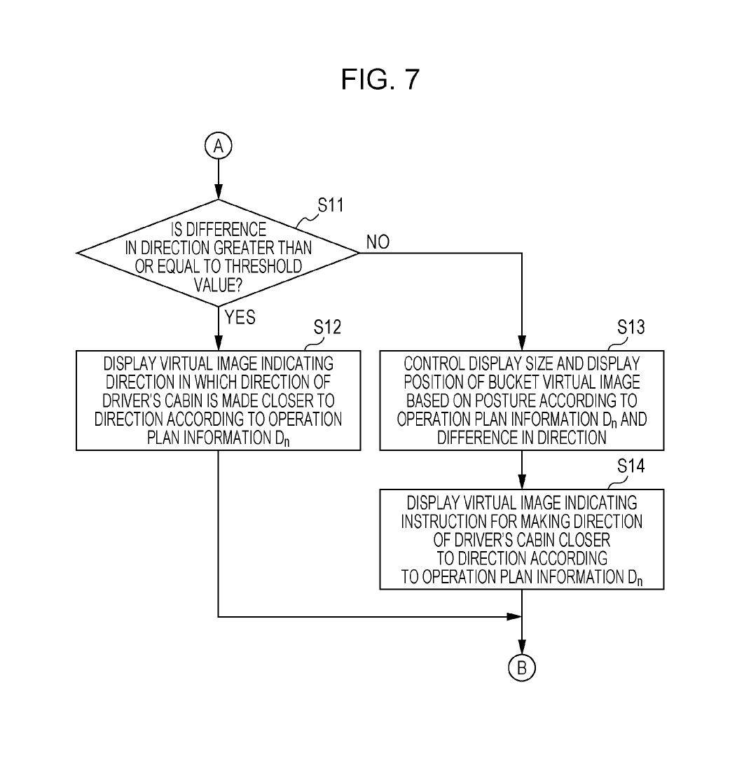

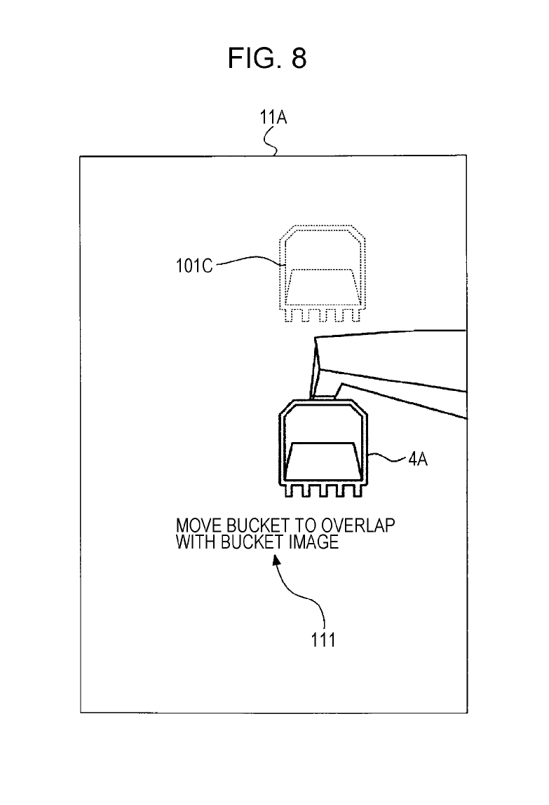

FIGS. 6 and 7 are flowcharts for describing operations of the system control unit 60 illustrated in FIG. 5. FIGS. 8 to 18 are schematic views illustrating display examples of the projection display unit 50.

In the HUD 10, a plurality of operation plan information items Dₙ (n is an integer of two or more) are stored in advance in the storage unit 70, and each of the plurality of operation plan information items Dₙ is stored in association with an operation execution order. Note that the value “n” is smaller as the execution order is earlier.

When the HUD 10 is started and is set to an operational support mode, the display control unit 63 first reads out an operation plan information item Dₙ whose execution order is first from the storage unit 70 (step S1).

Subsequently, on the basis of the direction information from the direction sensor 14 and the position information from the GPS receiver 15, the detection unit 61 detects the position of the construction machine 1 and the direction of the driver's cabin 5 (step S2).

Subsequently, the display control unit 63 determines whether the planned position according to the operation plan information that is read out from the storage unit 70 in step S1 corresponds with the detected position that is detected in step S2 (step S3).

In a case where the determination in step S3 is YES, the display control unit 63 determines whether the planned direction according to the operation plan information that is read out from the storage unit 70 in step S1 corresponds with the detected direction that is detected in step S2 (step S4).

In a case where the determination in step S4 is YES, on the basis of the planned posture specified by the operation plan information that is read out from the storage unit 70 in step S1, as illustrated in FIG. 8, the display control unit 63 causes the projection display unit 50 to display a bucket virtual image 101C representing the bucket 4A and a text image 111 indicating an instruction for overlapping the bucket 4A with the bucket virtual image 101C (step S5). The text image 111 is information indicating operation content of the bucket 4A. Note that the text image 111 is not necessarily displayed.

The bucket virtual image 101C virtually represents the bucket 4A observed within the projection area 11A from the driver's seat 6 in the state where the bucket 4A is in the planned posture. Accordingly, the operation of overlapping the bucket virtual image 101C and the bucket 4A with each other enables the position of the bucket 4A in a space to correspond with the planned position.

Upon display of the bucket virtual image in step S5, the overlap determining unit 62 determines whether the bucket virtual image and the bucket 4A overlap with each other (step S6).

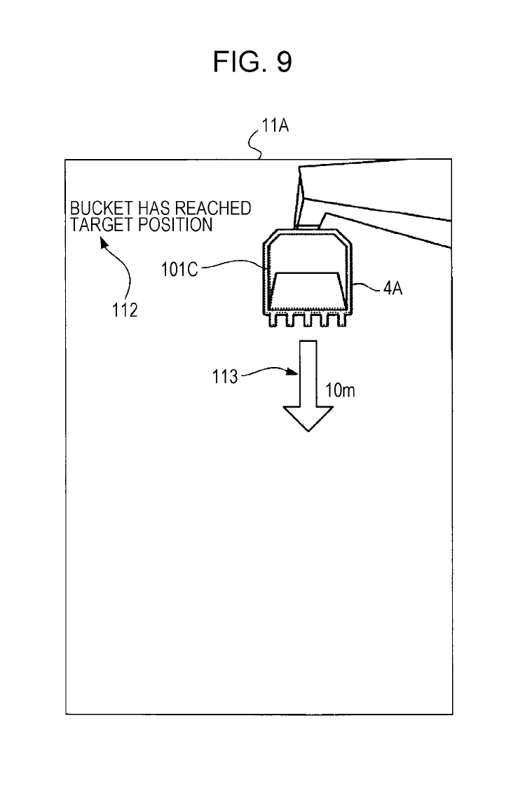

When the operator moves the bucket 4A upward, the state illustrated in FIG. 8 becomes the state illustrated in FIG. 9, and in a case where it is determined that the bucket virtual image 101C and the bucket 4A overlap with each other (step S6: YES), as illustrated in FIG. 9, the display control unit 63 causes the projection display unit 50 to display a text image 112 indicating that an optimal posture for starting digging is set and an image 113 indicating movement direction and a digging amount (10 m) of the bucket 4A (step S7). The text image 112 constitutes the report information.

After the images have been displayed as illustrated in FIG. 9, the display control unit 63 waits for an instruction for proceeding to the next operation plan information item Dₙ by the operator's manual operation. Upon receiving this instruction (step S8: YES), the display control unit 63 changes “n” to “n+1” (step S9), and the process returns to step S1. If the display control unit 63 does not receive this instruction (step S8: NO), the process returns to step S7 and continues the display in FIG. 9.

In a case where the display control unit 63 determines in step S4 that the planned direction according to the operation plan information that is read out from the storage unit 70 in step S1 does not correspond with the detected direction that is detected in step S2 (step S4: NO), the display control unit 63 determines whether the difference between the planned direction according to the operation plan information that is read out from the storage unit 70 in step S1 and the detected direction that is detected in step S2 is greater than or equal to a threshold value (FIG. 7, step S11).

In a case where the determination in step S11 is YES, the display control unit 63 does not display the bucket virtual image based on the planned posture, but causes the projection display unit 50 to display a rotation instruction virtual image indicating the direction of rotation of the driver's cabin 5, the rotation being necessary for making the direction of the driver's cabin 5 closer to the planned direction (step S12).

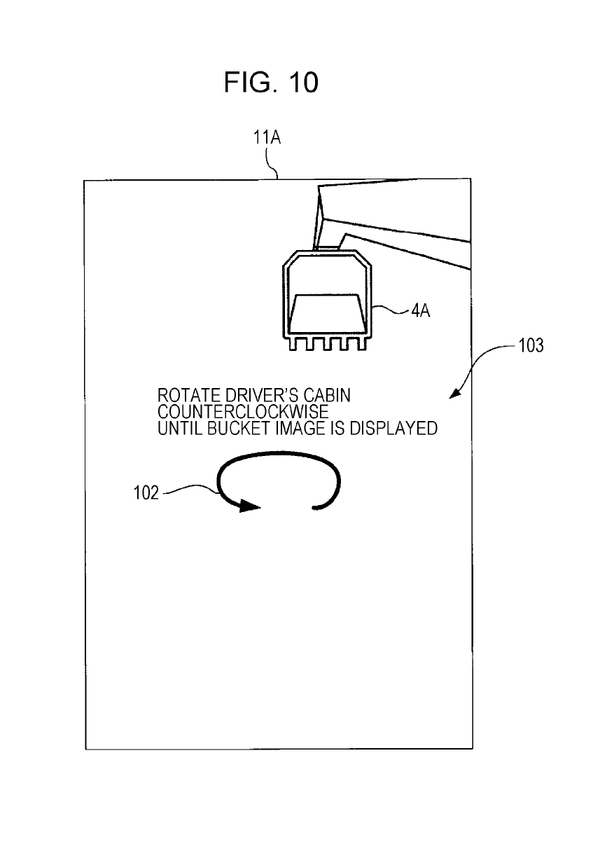

FIG. 10 illustrates a rotation arrow image 102 as the rotation instruction virtual image and a text image 103. The rotation arrow image 102 indicates an instruction for rotating the driver's cabin 5 counterclockwise. The text image 103 represents characters such as “ROTATE DRIVER'S CABIN COUNTERCLOCKWISE UNTIL BUCKET IMAGE IS DISPLAYED”. The rotation arrow image 102 and the text image 103 are information indicating an instruction for changing the direction of the driver's cabin 5.

In a case where the determination in step S11 is NO, on the basis of the planned posture according to the operation plan information that is read out from the storage unit 70 in step S1 and the difference between the planned direction according to the operation plan information that is read out in step S1 and the detected direction that is detected in step S2, the display control unit 63 determines the display position and display size of the bucket virtual image and causes the projection display unit 50 to display the bucket virtual image at the determined display position with the determined display size (step S13).

In the case where the determination in step S11 is NO, although the position of the construction machine 1 is according to the plan, the direction of the driver's cabin 5 is misaligned to the left or right from the planned direction.

Accordingly, in order to express the misalignment of this direction, the display control unit 63 controls the display position of the bucket virtual image on the basis of the difference between the planned direction and the detected direction without changing the display size of the bucket virtual image based on the planned posture included in the operation plan information.

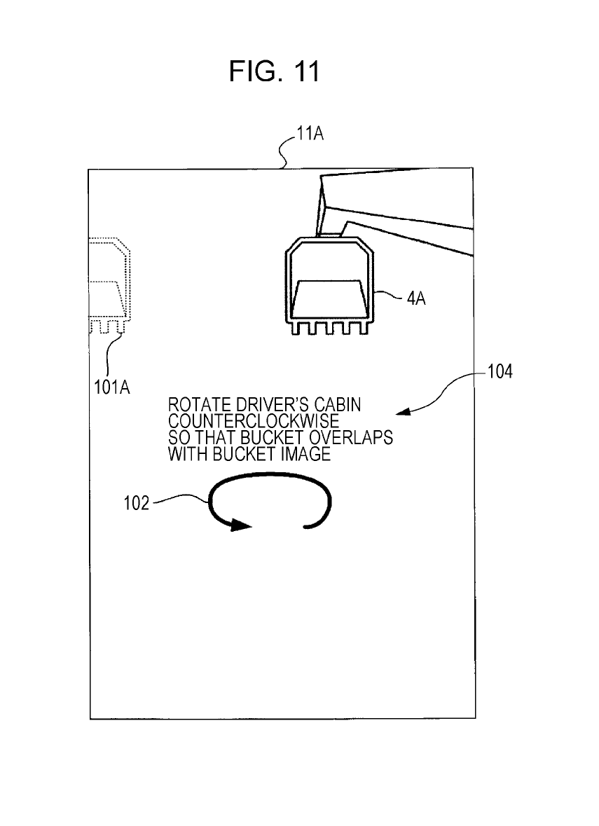

Specifically, in a case where the detected direction is on a more right side than the planned direction, as illustrated in FIG. 11, the display control unit 63 sets the display size of a bucket virtual image 101A to be the same as the display size in a case where the planned position corresponds with the detected position (the size of the bucket virtual image 101C illustrated in FIG. 8), and moves the display position to the left from the display position in a case where the planned direction corresponds with the detected direction by a difference that is proportional to the difference between the detected direction and the planned direction. Note that FIG. 11 illustrates a display example of a case where the driver's cabin 5 of the construction machine 1 is rotated counterclockwise from the state illustrated in FIG. 10.

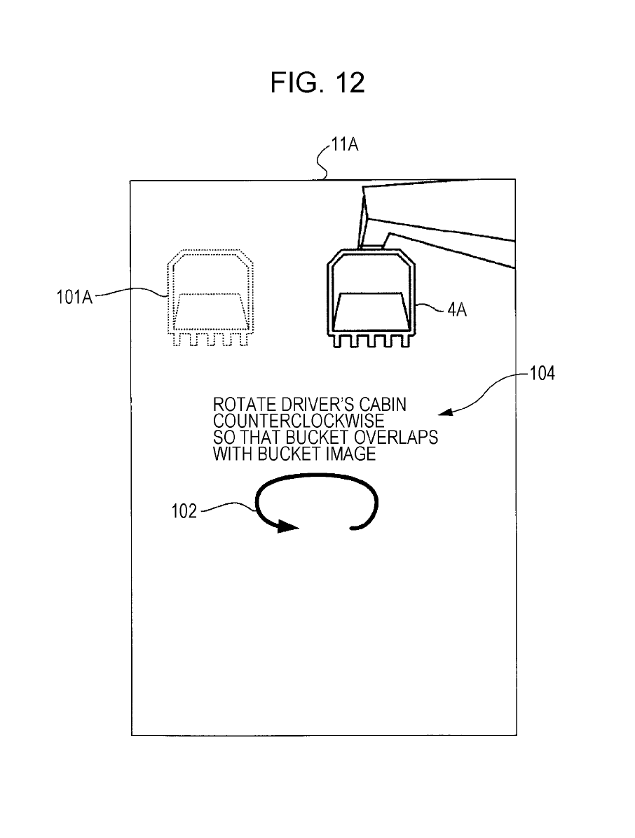

FIG. 12 illustrates a display example of a case where the driver's cabin 5 of the construction machine 1 is further rotated counterclockwise from the state illustrated in FIG. 11. In FIG. 12, since the difference between the planned direction and the detected direction is smaller than that in the case of FIG. 11, the bucket virtual image 101A is displayed at a position on a more right side than the bucket virtual image 101A in FIG. 11.

After the process in step S13, the display control unit 63 causes the projection display unit 50 to display a rotation instruction virtual image indicating an instruction for making the direction of the driver's cabin 5 closer to the planned direction according to the operation plan information (step S14).

FIGS. 11 and 12 illustrates examples of displaying, as the rotation instruction virtual images, the rotation arrow image 102 that is an image of counterclockwise rotation and a text image 104 such as “ROTATE DRIVER'S CABIN COUNTERCLOCKWISE SO THAT BUCKET OVERLAPS WITH BUCKET IMAGE”. The rotation arrow image 102 and the text image 104 illustrated in FIGS. 11 and 12 are information indicating operation content of the bucket 4A.

After the process in step S12 or the process in step S14, the process returns to step S4 in FIG. 6, and the process in step S11 to step S14 is performed until the planned direction corresponds with the detected direction.

In a case where it is determined in step S3 that the planned position according to the operation plan information that is read out from the storage unit 70 in step S1 does not correspond with the detected position that is detected in step S2 (step S3: NO), the display control unit 63 determines whether the planned direction according to the operation plan information that is read out from the storage unit 70 in step S1 corresponds with the detected direction that is detected in step S2 (step S15).

In a case where the determination in step S15 is YES, on the basis of the planned posture according to the operation plan information that is read out from the storage unit 70 in step S1 and the difference between the planned direction according to the operation plan information that is read out in step S1 and the detected direction that is detected in step S2, the display control unit 63 determines the display position and display size of the bucket virtual image and causes the projection display unit 50 to display the bucket virtual image at the determined display position with the determined display size (step S16).

In the case where the determination in step S15 is YES, although the direction of the driver's cabin 5 of the construction machine 1 is according to the plan, the position of the construction machine 1 is ahead of or behind the planned position.

Accordingly, in order to express the misalignment of this position, the display control unit 63 controls the display size of the bucket virtual image on the basis of the difference between the planned position and the detected position without changing the display position of the bucket virtual image based on the planned posture included in the operation plan information.

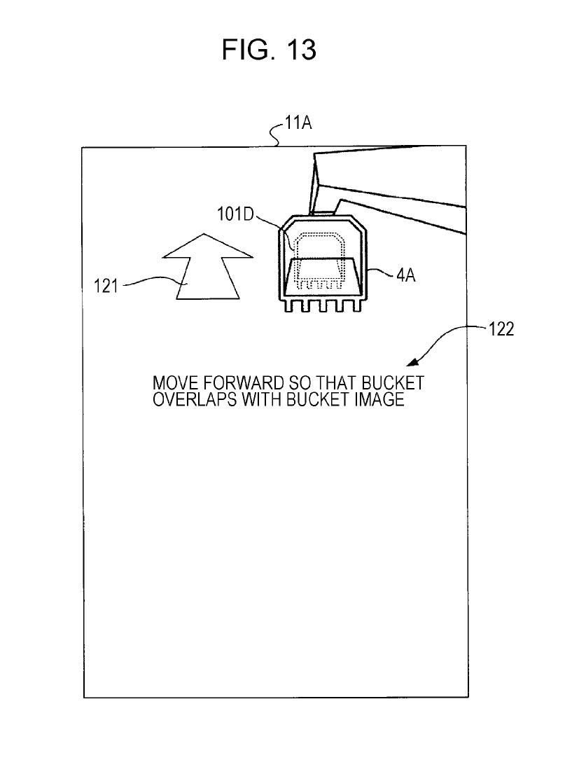

Specifically, in a case where the planned position is ahead of the detected position, as illustrated in FIG. 13, the display control unit 63 decreases the display size of a bucket virtual image 101D to be smaller than the display size in a case where the planned position corresponds with the detected position (the size of the bucket virtual image 101C illustrated in FIG. 8). As the difference between the planned position and the detected position is larger, the display control unit 63 decreases the display size of the bucket virtual image 101D.

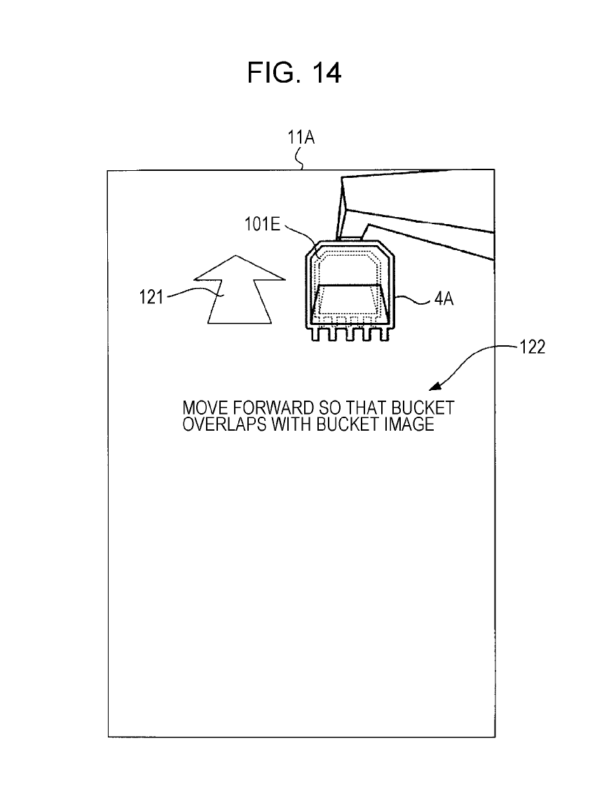

FIG. 14 illustrates a display state in a case where the construction machine 1 moves forward from the state illustrated in FIG. 13. In FIG. 14, since the difference between the planned position and the detected position is smaller than that in the case of FIG. 13, a bucket virtual image 101E with a larger size than the bucket virtual image 101D is displayed.

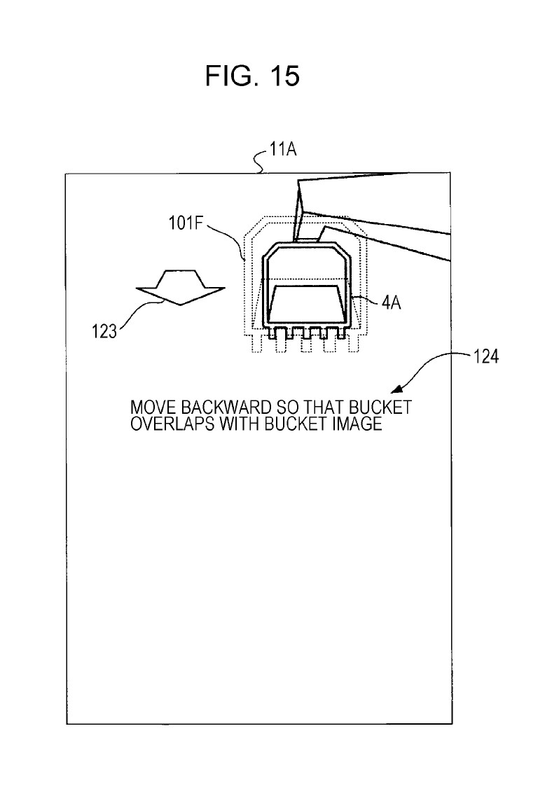

In addition, in a case where the planned position is behind the detected position, as illustrated in FIG. 15, the display control unit 63 increases the display size of a bucket virtual image 101F to be larger than the display size in a case where the planned position corresponds with the detected position (the size of the bucket virtual image 101C illustrated in FIG. 8). As the difference between the planned position and the detected position is larger, the display control unit 63 increases the display size of the bucket virtual image 101F.

After the process in step S16, the display control unit 63 causes the projection display unit 50 to display a movement instruction virtual image indicating an instruction for making the position of the construction machine 1 closer to the planned position included in the operation plan information (step S17).

FIGS. 13 and 14 illustrate examples of displaying, as the movement instruction virtual image, an arrow image 121 that is an image of moving forward and a text image 122 such as “MOVE FORWARD SO THAT BUCKET OVERLAPS WITH BUCKET IMAGE”.

FIG. 15 illustrates an example of displaying, as the movement instruction virtual images, an arrow image 123 that is an image of moving backward and a text image 124 such as “MOVE BACKWARD SO THAT BUCKET OVERLAPS WITH BUCKET IMAGE”. The arrow image 121, the text image 122, the arrow image 123, and the text image 124 are information indicating instructions of operation content of the bucket 4A.

After the process in step S17, the process returns to step S2.

In a case where the determination in step S15 is NO, the display control unit 63 determines whether the difference between the planned direction according to the operation plan information that is read out from the storage unit 70 in step S1 and the detected direction that is detected in step S2 is greater than or equal to the threshold value (step S18).

In a case where the determination in step S18 is YES, the display control unit 63 does not display the bucket virtual image based on the planned posture and causes the projection display unit 50 to display a movement instruction virtual image indicating the direction of movement of the construction machine 1, the movement being necessary to make the direction of the driver's cabin 5 closer to the planned direction (step S19).

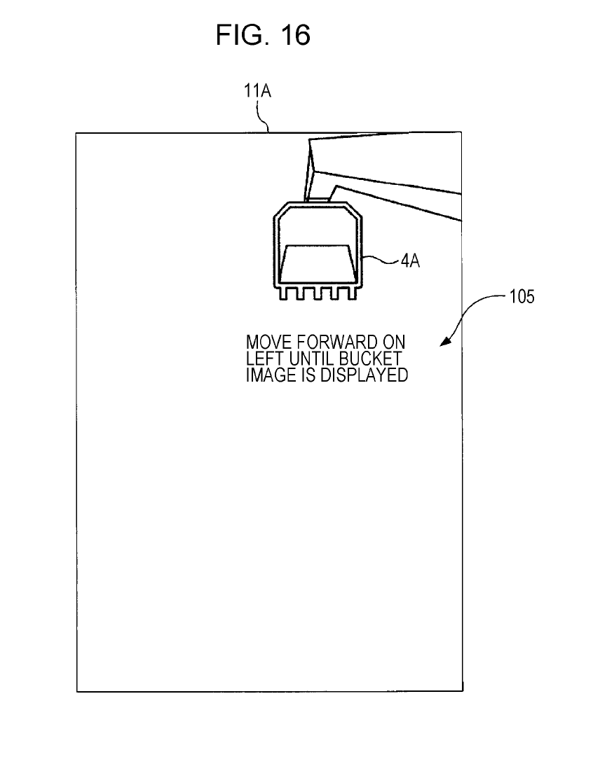

FIG. 16 illustrates, as the movement instruction virtual image, a text image 105 indicating an instruction for moving forward on the left. The text image 105 is information indicating an instruction for changing the position of the construction machine 1 and the direction of the driver's cabin 5.

In a case where the determination in step S18 is NO, on the basis of the planned posture according to the operation plan information that is read out from the storage unit 70 in step S1, the difference between the planned direction according to the operation plan information that is read out in step S1 and the detected direction that is detected in step S2, and the difference between the planned position according to the operation plan information that is read out in step S1 and the detected position that is detected in step S2, the display control unit 63 determines the display position and display size of the bucket virtual image and causes the projection display unit 50 to display the bucket virtual image at the determined display position with the determined display size (step S20).

The case where the determination in step S18 is NO corresponds to the state where the position of the construction machine 1 is misaligned from the plan and the direction of the driver's cabin 5 is slightly misaligned from the plan.

Accordingly, in order to express the misalignment of the position and the direction, the display control unit 63 controls the display position of the bucket virtual image based on the planned posture included in the operation plan information on the basis of the difference between the planned direction and the detected direction and controls the display size of the bucket virtual image based on the planned posture included in the operation plan information on the basis of the difference between the planned position and the detected position.

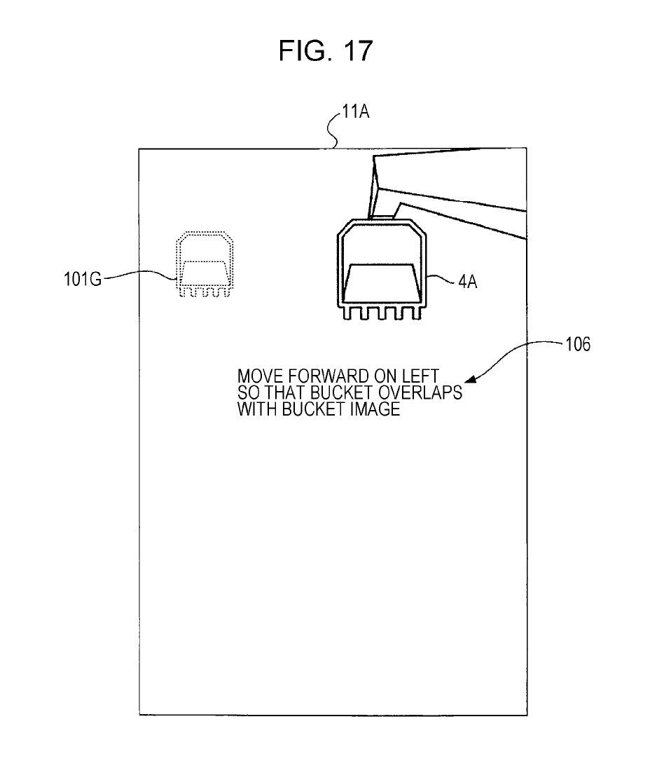

Specifically, in a case where the detected direction is on a more right side than the planned direction and the detected position is behind the planned position, as illustrated in FIG. 17, the display control unit 63 decreases the display size of a bucket virtual image 101G to be smaller than the display size in a case where the planned position corresponds with the detected position (the size of the bucket virtual image 101C illustrated in FIG. 8) in inverse proportion to the difference between the planned position and the detected position, and also moves the display position to a more left side than the display position in a case where the planned direction corresponds with the detected direction by the distance that is proportional to the difference between the detected direction and the planned direction. Note that FIG. 17 illustrates a display example of a case where the construction machine 1 moves forward on the left from the state illustrated in FIG. 16 and the bucket virtual image is displayed.

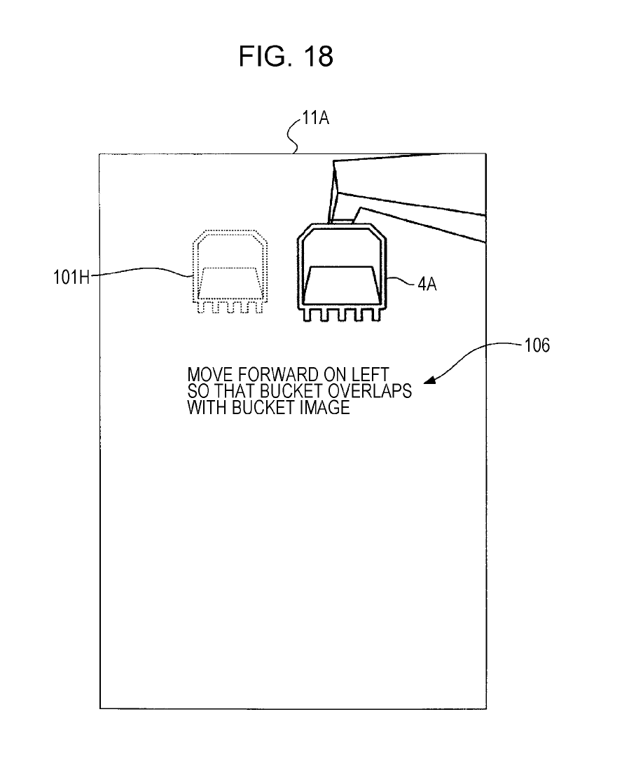

FIG. 18 illustrates a display example of a case where the construction machine 1 further moves forward on the left from the state illustrated in FIG. 17. In FIG. 18, since the difference between the planned direction and the detected direction is smaller than that in the case of FIG. 17, a bucket virtual image 101H is displayed at a position on a more right side than the bucket virtual image 101G. In addition, since the difference between the planned position and the detected position is smaller than that in the case of FIG. 17, the bucket virtual image 101H is displayed with a larger size than the bucket virtual image 101G.

After the process in step S20, the display control unit 63 causes the projection display unit 50 to display the movement instruction virtual image indicating an instruction for making the position of the construction machine 1 and the direction of the driver's cabin 5 closer to the planned position and planned direction according to the operation plan information (step S21).

FIGS. 17 and 18 illustrate an example of displaying a text image 106 such as “MOVE FORWARD ON LEFT SO THAT BUCKET OVERLAPS WITH BUCKET IMAGE” as the movement instruction virtual image.

After the process in step S19 or the process in step S21, the process returns to step S2.

As described above, with the HUD 10, on the basis of the operation plan information stored in the storage unit 70, the detected position of the construction machine 1, and the detected direction of the driver's cabin 5, the bucket image representing the bucket 4A can be displayed at a position indicating a digging point according to the plan.

Thus, the bucket virtual image enables the operator to check the position of the construction machine 1, the direction of the driver's cabin 5, and the posture of the bucket 4A that are appropriate for starting digging. Therefore, even in a case where an inexperienced operator performs an operation, by overlapping the bucket 4A with the bucket virtual image, the operator can start the operation in an appropriate state according to the operation plan information. This can realize the execution according to the plan without unnecessary movement, thereby improving the operation efficiency.

In addition, with the HUD 10, in a case where the bucket virtual image is not displayed, or in a case where the position of the construction machine 1 or the direction of the driver's cabin 5 is not according to the plan although the bucket virtual image is displayed, as illustrated in FIGS. 10 to 18 as examples, information indicating an instruction for changing at least one of the position of the construction machine 1 and the direction of the driver's cabin 5 is displayed. The operation of the construction machine 1 in accordance with this information enables the position of the construction machine 1 and the direction of the driver's cabin 5 to be aligned easily with the planned position of the construction machine 1 and the planned direction of the driver's cabin 5, thereby improving the operation efficiency.

Furthermore, with the HUD 10, in a case where it is determined that the bucket virtual image and the bucket 4A overlap with each other, as illustrated in FIG. 9, the text image 112 as the report information is displayed. Thus, the operator can easily understand that the bucket 4A is in an appropriate posture.

Note that in the display example of FIG. 9, instead of displaying the text image 112, it is possible to change a display color of the bucket virtual image 101C or to display the bucket virtual image 101C in a blinking manner so as to inform the operator that the posture of the bucket 4A corresponds to the planned posture. In this case, a part of the bucket virtual image 101C constitutes the report information.

In addition, instead of displaying the text image 112, a speaker may be added to the HUD 10, and the display control unit 63 may, by using the speaker, inform the operator that the posture of the bucket 4A corresponds to the planned posture. Furthermore, the display of the text image 112 may be combined with the change in the display color of the bucket virtual image 101C or the display of the bucket virtual image 101C in a blinking manner, or the display of the text image 112 may be combined with the report by using the speaker. Such a configuration enables the operator to perform the operation more accurately.

In addition, the text image 111 illustrated in FIG. 8, the rotation arrow image 102 illustrated in FIGS. 10 to 12, the text image 103 illustrated in FIG. 10, the text image 104 illustrated in FIGS. 11 and 12, the arrow image 121 and the text image 122 illustrated in FIGS. 13 and 14, the arrow image 123 and the text image 124 illustrated in FIG. 15, and the text image 106 illustrated in FIGS. 17 and 18 are not necessarily displayed. Furthermore, the ON state and the OFF state of the display of these images may be switched by the operator's operation.

For example, in a case where the operator considers that the display content projected onto the projection area 11A disturbs the operation, the display of images other than the bucket virtual image may be switched off so as to set a stable operation efficiency.

In addition, in the display example in FIG. 9, the display control unit 63 may further cause an execution scheme drawing to be displayed. Such a configuration enables the operator to perform the execution while checking an execution image, and the operation can be performed efficiently.

As described above, the following matters are disclosed herein.

(1) A projection display device to be mounted in a vehicle having a movable working machine and a main body part, the working machine being attached to the main body part, the main body part having a driver's cabin, the projection display device including:

a detection unit that detects a position of the vehicle and a direction of the driver's cabin;

a projection display unit that includes a light modulation unit that, on the basis of image information to be input, spatially modulates light emitted from a light source, and that projects image light, obtained through spatial modulation by the light modulation unit, onto a projection surface mounted in the driver's cabin to display a virtual image based on the image light; and

a display control unit that controls the image information to be input to the light modulation unit and that controls the virtual image that is to be displayed by the projection display unit,

wherein the display control unit causes the projection display unit to display a working-machine virtual image that represents the working machine on the basis of operation plan information and the position and the direction detected by the detection unit, the operation plan information specifying the position of the vehicle, the direction of the driver's cabin, and a posture of the working machine that are stored in a storage unit.

(2) The projection display device according to (1),

wherein the display control unit controls a display position of the working-machine virtual image on the basis of a difference between the direction specified by the operation plan information and the direction detected by the detection unit.

(3) The projection display device according to (1) or (2),

wherein the display control unit controls a display size of the working-machine virtual image on the basis of a difference between the position specified by the operation plan information and the position detected by the detection unit.

(4) The projection display device according to any one of (1) to (3),

wherein, in a case where the difference between the direction specified by the operation plan information and the direction detected by the detection unit is greater than or equal to a threshold value, the display control unit causes the projection display unit to display, instead of the working-machine virtual image, information indicating an instruction for changing the direction of the driver's cabin.

(5) The projection display device according to any one of (1) to (4), further including:

an overlap determining unit that determines whether the working-machine virtual image displayed by the projection display unit and the working machine overlap with each other in a state where seen from a driver's seat in the driver's cabin,

wherein, in a case where the overlap determining unit determines that the working-machine virtual image and the working machine overlap with each other, the display control unit informs an operator within the driver's cabin that the working machine is in an optimal posture.

(6) The projection display device according to (5),

wherein, in the case where the overlap determining unit determines that the working-machine virtual image and the working machine overlap with each other, the display control unit causes the projection display unit to display report information for informing the operator within the driver's cabin that the working machine is in the optimal posture.

(7) The projection display device according to (5),

wherein, in the case where the overlap determining unit determines that the working-machine virtual image and the working machine overlap with each other, the display control unit informs, by using a sound, the operator within the driver's cabin that the working machine is in the optimal posture.

(8) The projection display device according to any one of (1) to (7),

wherein, if the working-machine virtual image is being displayed, the display control unit further causes the projection display unit to display information indicating operation content of the working machine.

(9) A method for controlling a projection display device, the projection display device being to be mounted in a vehicle having a movable working machine and a main body part, the working machine being attached to the main body part, the main body part having a driver's cabin, the projection display device having

a light modulation unit that, on the basis of image information to be input, spatially modulates light emitted from a light source, and

a projection display unit that projects image light, obtained through spatial modulation by the light modulation unit, onto a projection surface mounted in the driver's cabin to display a virtual image based on the image light, the method including:

a detection step of detecting a position of the vehicle and a direction of the driver's cabin; and

a display control step of causing the projection display unit to display a working-machine virtual image that represents the working machine on the basis of operation plan information and the position and the direction detected in the detection step, the operation plan information specifying the position of the vehicle, the direction of the driver's cabin, and a posture of the working machine that are stored in a storage unit.

(10) The method for controlling a projection display device according to (9),

wherein, in the display control step, a display position of the working-machine virtual image is controlled on the basis of a difference between the direction specified by the operation plan information and the direction detected in the detection step.

(11) The method for controlling a projection display device according to (9) or (10),

wherein, in the display control step, a display size of the working-machine virtual image is controlled on the basis of a difference between the position specified by the operation plan information and the position detected in the detection step.

(12) The method for controlling a projection display device according to any one of (9) to (11),

wherein, in the display control step, in a case where the difference between the direction specified by the operation plan information and the direction detected in the detection step is greater than or equal to a threshold value, the projection display unit is caused to display, instead of the working-machine virtual image, information indicating an instruction for changing the direction of the driver's cabin.

(13) The method for controlling a projection display device according to any one of (9) to (12), further including:

an overlap determining step of determining whether the working-machine virtual image displayed by the projection display unit and the working machine overlap with each other in a state where seen from a driver's seat in the driver's cabin,

wherein, in a case where it is determined in the overlap determining step that the working-machine virtual image and the working machine overlap with each other, in the display control step, an operator within the driver's cabin is informed that the working machine is in an optimal posture.

(14) The method for controlling a projection display device according to (13),

wherein, in the case where it is determined in the overlap determining step that the working-machine virtual image and the working machine overlap with each other, in the display control step, the projection display unit is caused to display report information for informing the operator within the driver's cabin that the working machine is in the optimal posture.

(15) The method for controlling a projection display device according to (13),

wherein, in the case where it is determined in the overlap determining step that the working-machine virtual image and the working machine overlap with each other, in the display control step, by using a sound, the operator within the driver's cabin is informed that the working machine is in the optimal posture.

(16) The method for controlling a projection display device according to any one of (9) to (15),

wherein, in a case where the working-machine virtual image is being displayed, in the display control step, the projection display unit is further caused to display information indicating operation content of the working machine.

(17) A program for controlling a projection display device, the projection display device being to be mounted in a vehicle having a movable working machine and a main body part, the working machine being attached to the main body part, the main body part having a driver's cabin, the projection display device having

a light modulation unit that, on the basis of image information to be input, spatially modulates light emitted from a light source, and

a projection display unit that projects image light, obtained through spatial modulation by the light modulation unit, onto a projection surface mounted in the driver's cabin to display a virtual image based on the image light, the program causing a computer to execute:

a detection step of detecting a position of the vehicle and a direction of the driver's cabin; and

a display control step of causing the projection display unit to display a working-machine virtual image that represents the working machine on the basis of operation plan information and the position and the direction detected in the detection step, the operation plan information specifying the position of the vehicle, the direction of the driver's cabin, and a posture of the working machine that are stored in a storage unit.

According to the present invention, it is possible to increase the operation efficiency of a vehicle having a working machine, such as a construction machine or an agricultural machine.

### REFERENCE SIGNS LIST

1 construction machine
2 undercarriage
3 upper rotatable body
4 front operation unit
4A bucket
5 driver's cabin
6 driver's seat
10 HUD
11 front windshield
11A projection area
14 direction sensor
15 GPS receiver
40 light source unit
40A light source control unit
41r R light source
41g G light source
41b B light source
42r, 42g, 42b collimator lens
43 dichroic prism
44 light modulation element
45 driving unit
46 projection optical system
47 diffusion plate
48 reflective mirror
49 magnifying glass
50 projection display unit
60 system control unit
61 detection unit
62 overlap determining unit
63 display control unit
70 storage unit
80 sensors
101A, 101C, 101D, 101E, 101F, 101G, 101H bucket virtual image
103, 104, 105, 106, 111, 112, 122, 124 text image
102 rotation arrow image
113 image
121, 123 arrow image

What is claimed is:

1. A projection display device to be mounted in a vehicle having a movable working machine and a main body part, the working machine being attached to the main body part, the main body part having a driver's cabin, the projection display device comprising:
a detection unit that detects a position of the vehicle and a direction of the driver's cabin;
a projection display unit that includes a light modulation unit that, on the basis of image information to be input, spatially modulates light emitted from a light source, and that projects image light, obtained through spatial modulation by the light modulation unit, onto a projection surface mounted in the driver's cabin to display a virtual image based on the image light; and
a display control unit that controls the image information to be input to the light modulation unit and that controls the virtual image that is to be displayed by the projection display unit,
wherein the display control unit causes the projection display unit to display a working-machine virtual image that represents the working machine on the basis of operation plan information and the position and the direction detected by the detection unit, the operation plan information specifying the position of the vehicle, the direction of the driver's cabin, and a posture of the working machine that are stored in a storage unit.

2. The projection display device according to claim 1,
wherein the display control unit controls a display position of the working-machine virtual image on the basis of a difference between the direction specified by the operation plan information and the direction detected by the detection unit.

3. The projection display device according to claim 1,
wherein the display control unit controls a display size of the working-machine virtual image on the basis of a difference between the position specified by the operation plan information and the position detected by the detection unit.

4. The projection display device according to claim 2,
wherein the display control unit controls a display size of the working-machine virtual image on the basis of a difference between the position specified by the operation plan information and the position detected by the detection unit.

5. The projection display device according to claim 2,
wherein, in a case where the difference between the direction specified by the operation plan information and the direction detected by the detection unit is greater than or equal to a threshold value, the display control unit causes the projection display unit to display, instead of the working-machine virtual image, information indicating an instruction for changing the direction of the driver's cabin.

6. The projection display device according to claim 1, further comprising:
an overlap determining unit that determines whether the working-machine virtual image displayed by the projection display unit and the working machine overlap with each other in a state where seen from a driver's seat in the driver's cabin,
wherein, in a case where the overlap determining unit determines that the working-machine virtual image and the working machine overlap with each other, the display control unit informs an operator within the driver's cabin that the working machine is in an optimal posture.

7. The projection display device according to claim 2, further comprising:
an overlap determining unit that determines whether the working-machine virtual image displayed by the projection display unit and the working machine overlap with each other in a state where seen from a driver's seat in the driver's cabin,
wherein, in a case where the overlap determining unit determines that the working-machine virtual image and the working machine overlap with each other, the display control unit informs an operator within the driver's cabin that the working machine is in an optimal posture.

8. The projection display device according to claim 3, further comprising:
an overlap determining unit that determines whether the working-machine virtual image displayed by the projection display unit and the working machine overlap with each other in a state where seen from a driver's seat in the driver's cabin,
wherein, in a case where the overlap determining unit determines that the working-machine virtual image and the working machine overlap with each other, the display control unit informs an operator within the driver's cabin that the working machine is in an optimal posture.

9. The projection display device according to claim 6,
wherein, in the case where the overlap determining unit determines that the working-machine virtual image and the working machine overlap with each other, the display control unit causes the projection display unit to display report information for informing the operator within the driver's cabin that the working machine is in the optimal posture.

10. The projection display device according to claim 6,
wherein, in the case where the overlap determining unit determines that the working-machine virtual image and the working machine overlap with each other, the display control unit informs, by using a sound, the operator within the driver's cabin that the working machine is in the optimal posture.

11. The projection display device according to claim 1,
wherein, if the working-machine virtual image is being displayed, the display control unit further causes the projection display unit to display information indicating operation content of the working machine.

12. A method for controlling a projection display device, the projection display device being to be mounted in a vehicle having a movable working machine and a main body part, the working machine being attached to the main body part, the main body part having a driver's cabin, the projection display device having
a light modulation unit that, on the basis of image information to be input, spatially modulates light emitted from a light source, and
a projection display unit that projects image light, obtained through spatial modulation by the light modulation unit, onto a projection surface mounted in the driver's cabin to display a virtual image based on the image light, the method comprising:
a detection step of detecting a position of the vehicle and a direction of the driver's cabin; and
a display control step of causing the projection display unit to display a working-machine virtual image that represents the working machine on the basis of operation plan information and the position and the direction detected in the detection step, the operation plan information specifying the position of the vehicle, the direction of the driver's cabin, and a posture of the working machine that are stored in a storage unit.

13. The method for controlling a projection display device according to claim 12,
wherein, in the display control step, a display position of the working-machine virtual image is controlled on the basis of a difference between the direction specified by the operation plan information and the direction detected in the detection step.

14. The method for controlling a projection display device according to claim 12,
wherein, in the display control step, a display size of the working-machine virtual image is controlled on the basis of a difference between the position specified by the operation plan information and the position detected in the detection step.

15. The method for controlling a projection display device according to claim 13,
wherein, in the display control step, in a case where the difference between the direction specified by the operation plan information and the direction detected in the detection step is greater than or equal to a threshold value, the projection display unit is caused to display, instead of the working-machine virtual image, information indicating an instruction for changing the direction of the driver's cabin.

16. The method for controlling a projection display device according to claim 12, further comprising:
an overlap determining step of determining whether the working-machine virtual image displayed by the projection display unit and the working machine overlap with each other in a state where seen from a driver's seat in the driver's cabin,
wherein, in a case where it is determined in the overlap determining step that the working-machine virtual image and the working machine overlap with each other, in the display control step, an operator within the driver's cabin is informed that the working machine is in an optimal posture.

17. The method for controlling a projection display device according to claim 16,
wherein, in the case where it is determined in the overlap determining step that the working-machine virtual image and the working machine overlap with each other, in the display control step, the projection display unit is caused to display report information for informing the operator within the driver's cabin that the working machine is in the optimal posture.

18. The method for controlling a projection display device according to claim 16,
wherein, in the case where it is determined in the overlap determining step that the working-machine virtual image and the working machine overlap with each other, in the display control step, by using a sound, the operator within the driver's cabin is informed that the working machine is in the optimal posture.

19. The method for controlling a projection display device according to claim 12,
wherein, in a case where the working-machine virtual image is being displayed, in the display control step, the projection display unit is further caused to display information indicating operation content of the working machine.

20. A non-transitory computer readable recording medium storing a program for controlling a projection display device, the projection display device being to be mounted in a vehicle having a movable working machine and a main body part, the working machine being attached to the main body part, the main body part having a driver's cabin, the projection display device having
a light modulation unit that, on the basis of image information to be input, spatially modulates light emitted from a light source, and
a projection display unit that projects image light, obtained through spatial modulation by the light modulation unit, onto a projection surface mounted in the driver's cabin to display a virtual image based on the image light, the program causing a computer to execute:
a detection step of detecting a position of the vehicle and a direction of the driver's cabin; and
a display control step of causing the projection display unit to display a working-machine virtual image that represents the working machine on the basis of operation plan information and the position and the direction detected in the detection step, the operation plan information specifying the position of the vehicle, the direction of the driver's cabin, and a posture of the working machine that are stored in a storage unit.
